(19) United States
(12) Patent Application Publication
(10) Pub. No.: US 2024/0346053 A1
(43) Pub. Date: Oct. 17, 2024

(54) DATA COLLECTION, DISTRIBUTION AND ANALYSIS METHODOLOGY FOR REALTIME AND HISTORICAL GIS DATA

(71) Applicant: Monmouth University, West Long Branch, NJ (US)

(72) Inventors: Raman Lakshmanan, Long Branch, NJ (US); Ava Taylor, Marlboro, NJ (US)

(21) Appl. No.: 18/635,475

(22) Filed: Apr. 15, 2024

Related U.S. Application Data
(60) Provisional application No. 63/459,092, filed on Apr. 13, 2023.

(51) Int. Cl. G06F 16/29; G08B 21/10

(52) U.S. Cl. CPC G06F 16/29; G08B 21/10

(57) ABSTRACT

A method and system for a weather distribution adapted to collect, analyze and distribute user reported flood data, including a user interface adapted for a user to report flood data, receive a flood alert and view displayed analyzed reported flood data relevant to the user, and a central cloud network adapted to collect, analyze, and distribute the reported flood data to the user, the central cloud network including a report handler, wherein the report handler collects the reported flood data, analyzes the reported flood data and distributes the analyzed reported flood data to a memory database and a geographic information system (“GIS”) database, the memory database, wherein the memory database stores user information and locations, the GIS database, wherein the GIS database records the analyzed reported flood data, a notification trigger system, wherein the notification trigger system sends the user the flood alert and displays the analyzed reported flood data based on a user location, wherein the automatic updates display reported flood data in real-time.

This application claims priority to U.S. Provisional Patent Application No. 63/459,092, filed Apr. 13, 2023, entitled “DATA COLLECTION, DISTRIBUTION AND ANALYSIS METHODOLOGY FOR REALTIME AND HISTORICAL GIS DATA,” which is hereby incorporated by reference in its entirety.

The present invention provides a system and method for local flood data collection and distribution.

### BACKGROUND

In recent years, flooding has become a weather event that has caused large amounts of damage and loss of life. The current emergency alert systems are not as effective as they could be in protecting the public from dangers during flood events. There is a lack of real time flood data at a local level. Furthermore, there is no central repository to search historical flood data or an effective and an easy way to use the processed collected data.

The Emergency alert systems that currently exist have various issues such as causing user alert fatigue, communication disparities, message composition/proper recipient errors and data deficiency. Alert fatigue is an issue in which people begin to ignore alerts because they are not always accurate or do not pertain to the user receiving them. This results in people ignoring alerts that may be important and information that could possibly save their lives. Because we live in a diverse country with many citizens speaking different first languages, communication barriers exist. Message composition may be an issue reaching a wider array of messages due to the language/s used to broadcast important informational messages. The alerts the user receives is strongly dependent on the composition of the message they receive. Furthermore, there is a data deficiency that makes providing overall flood information difficult and even more difficult for predicting small yet intense floods. Therefore, most flooding predictions currently forecasted are for large-scale, highly devastating floods. The current systems are unable to easily and quickly determine when a risk is high and send out flash flood warnings in a timely manner.

Physical, semi-physical and image processing systems are currently the most frequently used flood prediction systems. Physical systems couple meteorological data, overland physical parameters and underground flowage systems. Semi-physical systems rely on cell computation of discretized space that encompasses a cell state, a time step and a set of transition rules to other neighboring cells. Image processing methods rely on continuous input of real-time closed-circuit television, satellite or radar images. These methods do not provide the most accurate and time efficient public flooding alerts on their own.

Using mobile applications crowdsourced data can be collected and presented to users in real time. A current application using this method is “Dark Sky,” which provides hyperlocal weather data to its users and can alert them when rain will start or stop. This may be helpful for day-to-day weather events; however it does not provide detailed information for major weather events such as flooding.

Mobile applications such as “MyCoast,” and “Sea Level Rise,” are limited to coastal areas for coastal events and sea level rising or crowdsourcing web data geo-forms have emerged for resiliency purposes.

### SUMMARY

The present invention provides a weather distribution system adapted to collect, analyze and distribute user reported flood data, the system including a user interface adapted for a user to report flood data, receive a flood alert and view displayed analyzed reported flood data relevant to the user, and a central cloud network adapted to collect, analyze, and distribute the reported flood data to the user, the central cloud network including a report handler, wherein the report handler collects the reported flood data, analyzes the reported flood data and distributes the analyzed reported flood data to a memory database and a geographic information system (“GIS”) database, the memory database, wherein the memory database stores user information and locations, the GIS database, wherein the GIS database records the analyzed reported flood data, a notification trigger system, wherein the notification trigger system sends the user the flood alert and displays the analyzed reported flood data based on a user location, wherein the system automatically updates the displayed reported flood data in real-time.

The present invention also provides a method for collecting and distributing the flood reported flood data in real time to a user, the method including one or more users registering on a flood data system, the one or more users logging into the flood data system, the one or more users reporting flood data to the system, analyzing the reported flood data, storing the analyzed reported flood data, and displaying all of the analyzed reported flood data on a user interface in a based on a user's location.

### BRIEF DESCRIPTION OF THE DRAWINGS

Further objects, features and advantages of the invention will become apparent from the following detailed description taken in conjunction with the accompanying figures showing illustrative embodiments of the invention, in which:

FIG. 1 shows an exemplary embodiment of the service architecture and data flow of the present invention;

FIG. 2 shows an exemplary embodiment of a user interface to report a flood;

FIG. 3 shows an exemplary embodiment of a user interface for a user to input specific flood data;

FIG. 4 shows an exemplary embodiment of a user interface showing a current flood map;

FIG. 5 shows an exemplary embodiment of a user interface showing flood trends;

FIG. 6 shows an exemplary embodiment of a user interface showing an advanced search option for user flood history settings;

FIG. 7 shows an exemplary embodiment of a user interface showing an advanced search map based option for flood history settings; and

FIG. 8 shows an exemplary embodiment of a user interface for a flood history chart.

### DETAILED DESCRIPTION OF THE INVENTION

The present invention provides a system and method for collecting flood data and the distribution of this data in real time. The present invention provides an effective way for information to reach the public in the event of a flood. Through the use of crowd sourced data and a user interface such as a browser or mobile application for example, users can report their own flood data and analyze other reported real time data, which provides more accurate information about the dangers of a particular flood. The present invention allows users to access to an array of flooding information such as seeing specific areas and streets that are flooded, where flooding may be increasing or decreasing, if there are hazards in the roads, and the depth of the flooded areas, for example. All of this information is based on reports submitted by other users. The present invention enhances weather reporting systems reducing mortality rates and damages caused by natural flooding disasters. Since flooding is typically seen as a non-threatening weather event, alerts for flooding are often dismissed, ignored and not taken seriously. Receiving data from one's fellow citizens and local community provides the user with information that is accurate to the user's specific location.

Crowdsourcing is a term to describe real-time data collection from various collaborative sources which may include social media, citizen science, and cameras, for example. People can report any observed data with descriptive text and/or photo/video evidence at any time. The present invention combines the cost-effective way to collect and distribute flood data through crowdsourcing, an easy to use user interface such as via a mobile application having a full map-based interface, and cloud based services to distribute the data in real time, improving the existing flood alert systems. Users that receive less frequent and more concise information are more likely to be aware and pay attention to the shared information and therefore be able to respond to an alert in an appropriate and timely manner. Having more accurate models of weather data through crowdsourcing, the occurrence of inaccurate warnings is less likely and alert fatigue can be reduced.

Using GIS framework and crowdsourcing provides location-specific information, which is a key benefit to its effectiveness of the system. Users can upload data in real-time directly from their mobile devices, for example. Requiring users to upload images of the location they are reporting data on contributes to the verification of their report.

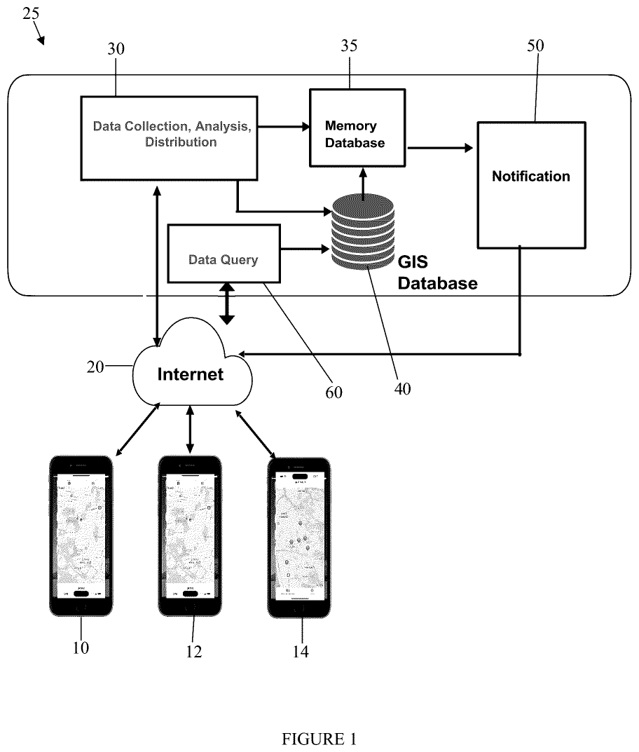

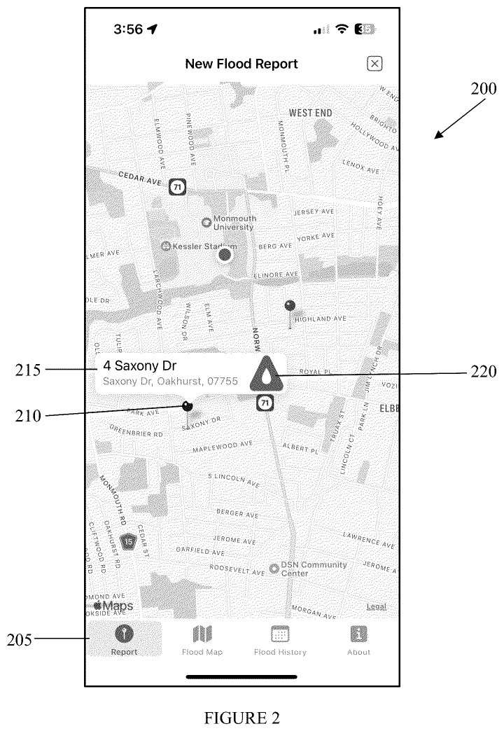

FIG. 1 shows an exemplary embodiment of the system service architecture and data flow for the present invention. One or more users report local flood information with tags into the respective one or more mobile user devices 10, 12, 14, such as a cell phone or tablet, via a mobile application, for example. Users can submit their reports on their maps via the user interface, for example. This information is sent over a wireless interface 20 to cloud based services 25 which includes report handler 30, memory database 35. geographic information system (“GIS”) database 40, and notification handler 50. Wireless interface 20 may consist of a multitude of connections of network interfaces such as cellular, Wi-Fi, RFID, satellite, LTE, and 5G encompassing local area network (LAN) and wide area network (WAN). Report handler 30 collects, analyzes and processes the submitted data and then distributes the data to memory database 35 and GIS centric database 40 for recording. Location of the report, location of the user and all the associated data along with a timestamp record in GIS database 40 and in Memory Database 35. Notification handler 50 pushes live flood reports to users mobile devices 10, 12, 14 based on their location. Flood data reports pushed to users interface, such as mobile devices, based on their location is displayed on the flood map 200 (seen in FIG. 2) with information provided about them. This data may also be stored on the GIS database for more advanced analytics and queries such as removing datapoints when necessary. Memory database 35 provides short term storage for the data, for example, the last two hours. The processed reports are delivered to GIS database 40 and recorded in GIS database 40. (GIS is a term used to describe computer systems based around mapping. It is a database that contains geographic data and performs tasks with the data such as analyzing and displaying it). GIS database 40 sends analyzed data to memory database 35 which is then sent to trigger notification service 50. Notification service 50 sends notifications to the user over the network via their user interface on mobile devices 10, 12, 14, for example. Notifications may be transmitted to the user via an application, email, SMS or a website, for example. Historical queries 60 may be run using information recorded in GIS 40.

In order to access the system, a user must register. The user may create an account on a computer via a browser or a mobile device via a mobile application, for example. This can be done using identifying information of the user such as a user's phone number and/or zip code, for example. Users can access their account on different devices. Once the user has a registered account, they can sign into the system using the same registered login information to access the user interface. The user interface includes all user interaction modalities such as a personal computer, a mobile device, or any other suitable device, software, interactive modality or other mechanism able to integrate, manipulate and/or operate the system and allow a user to input information. A user is asked to grant the system access to their location, allowing the system to pinpoint the user's location and for the user to easily view data local to their location. A map screen can be viewed in which the user is given the option to make a flood report. The system acts as a source with a variety of different data for a user to use to determine if they are at risk of a flood disaster. Crowdsourcing allows the user to update information on areas they see flooding. Once logged into the system, a user can view the current flood report 200 in nearby areas as seen in FIG. 2. A user can report a flood by selecting “Report” 205. Flood Report 200 shows the user's current location. To report a flood, the user drops a location pin 210 for the location where a flood currently exists. The user can select the spot of the pin by touching and holding the finger down on the spot of interest, for example. Touching the pin shows street level information 215 and can be moved accordingly to designate the proper location. Once a pin has been placed at a precise location, the user selects water icon 220.

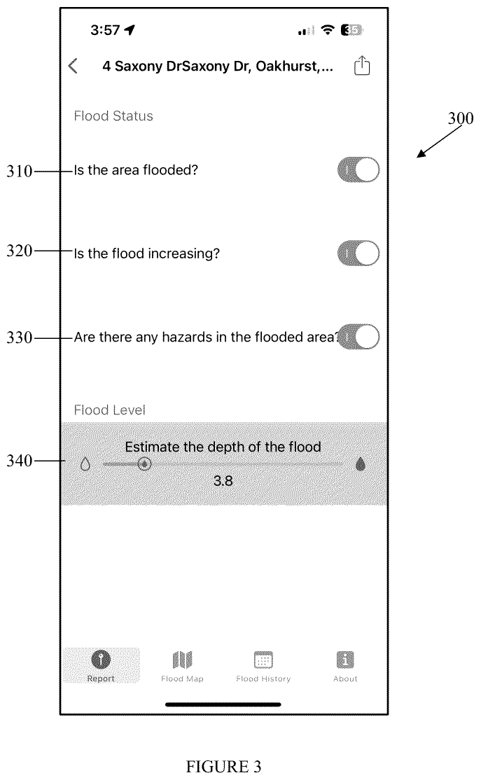

FIG. 3 shows an exemplary embodiment of user interface 300, where the user can submit/enter flood related data being reported. The information shared may include answering questions such as “Is the area flooded?” 310, “Is the flood increasing?” 320, “Are there hazards in the flooded area?” 330, and “estimate the depth of the flood” 340 and additional tags associated with the report (for example, name of the storm, weather conditions such as wind speed and direction, images and videos). Once all the data is entered by the user a report is sent to the report handler via a wireless interface. With the user's permission, the location of the user may also be sent to the service periodically to use in the Flood Map to confirm the accuracy of the information provided to and from the user. Each user interface of the system automatically geolocates the user's location based on wireless geolocation, GPS interface or IP geolocation. Geolocation coordinates of the user interface or flood report are determined at from a geolocation database query, automatic geolocation with cellular or Wi-Fi triangulation, GPS, manual input, or other methods. Using a real-time database and crowdsourcing allows the system to be highly accurate as it is constantly updating and being updated with user information.

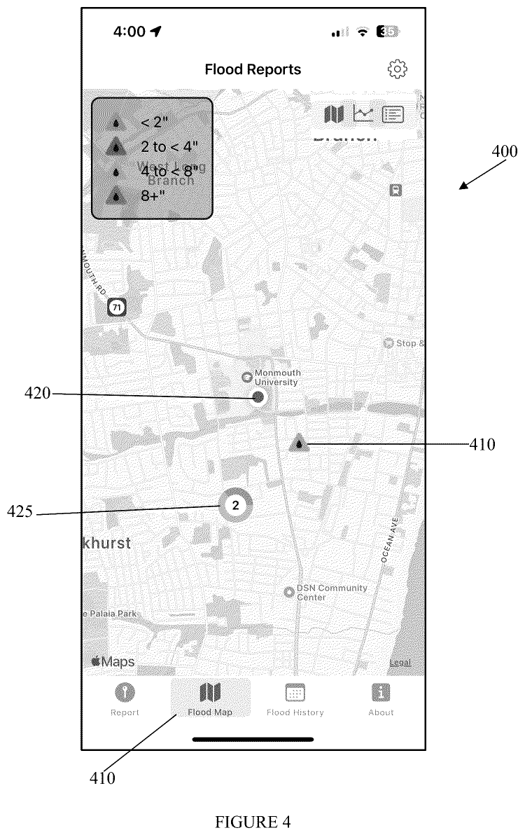

FIG. 4 shows and exemplary embodiment of flood map 400 showing all of the current flood active flood reports around the user's location or selected location. Users can move to a second tab of all active flood reports 400 and view flood map 405 providing information on what streets are flooded shown as marker 410 and as cluster makers 425. Cluster marker 425 displays the number of reports submitted for that location. This number presented in the marker will automatically increase as more reports are submitted for/from that location, providing a live view of flooding data in the area.

The flooded street information can be used by a user to determine an escape route if they need to evacuate. The system may provide an accurate evacuation route to travel from point A to point B avoiding flood areas and flooded streets with the user selecting a maximum water level. For example, a driver with a SUV or truck can chose roads with less than 6 inches of water while a user with a sedan may choose roads with less than 2 inches of water. This routing solution is based on water levels from the collected data, however, evacuation routes may be based on other criteria.

Any report a user makes, immediately shows up on flood map 405. By clicking any of report pins 420 on flood map 405, the user can see all of the data that has been reported by themselves and other users about that pin location flood. The user may zoom in and out on flood map 405, showing data clusters based on proximity to the user or other selected points. The clusters contain multiple reports from the same location. Clicking on a cluster will display a summary of the information for all the points in the cluster. Map clusters may also be provided that show how many reports are in the given location with color coding showing the average in the cluster. The user can select an individual report or a cluster to see specific information on the reported data. The user also has the option to report an update to an existing data point, such as flood level increasing from what was previously reported.

Current Flood Map 400, as shown in FIG. 4, shows all of the reported flood data near a user's location. This information may be filtered by timeframe of report, flood level, increasing/decreasing, distance from user or hazards, for example. The user's location and filtering rules are mapped to a unique identifier using a hashing algorithm. All data is recorded in the GIS database and the more recent data (the last 15 minutes, for example) also resides in the memory-based database for a fast and efficient search to notify the user when new reports are posted. For example, the algorithm identifies user's based on their selected filters, such as, Does the posted location fall into the area? Within a time range? Or other rules for one or more users. For the user's that meet the criteria, notification service is triggered to push the posted information of new reports in real time to the applicable users. Flood map 400 shows the new report sent to the user

Color coding may be used to distinguish the different flood levels on the map. For example, yellow may signify less than 2 inches, blue may signify 2 to 4 inches, orange may signify 4 to 8 inches and red may signify more than 8 inches. Flood map 400 allows users to zoom-in and zoom-out of the areas to see the reported flood.

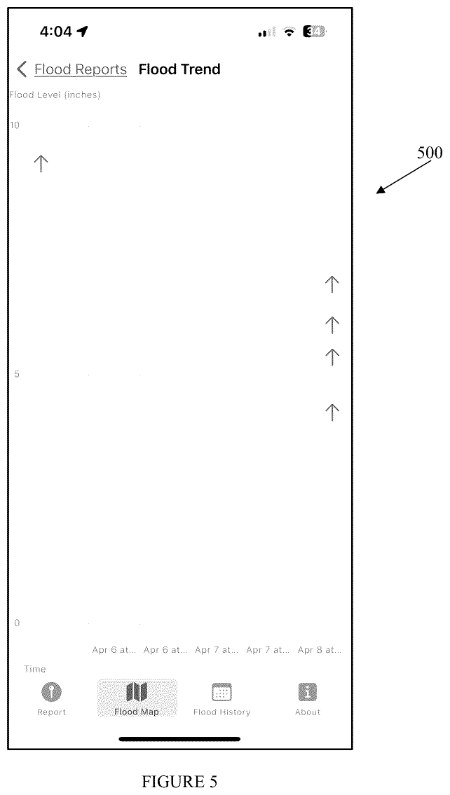

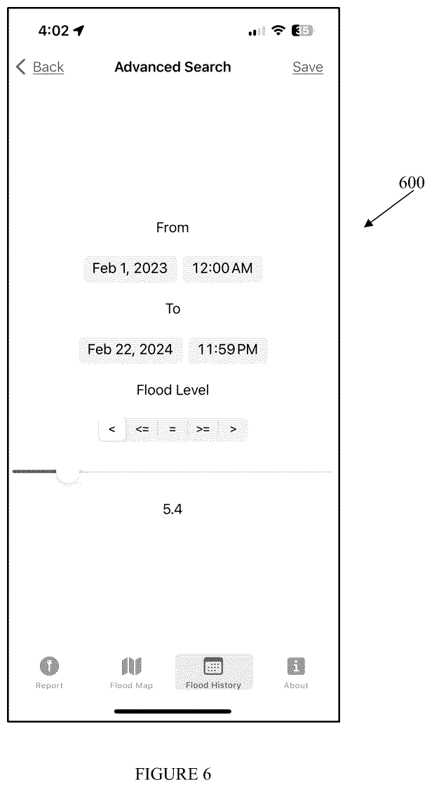

Exemplary chart 500, as shown in FIG. 5, shows flood level trends on different days or different times, for example, based on the collected and/or historical data. Users can also conduct advanced searches of historical data 600, as exampled in FIG. 6, allowing the user to select a date range such as Feb. 1, 2023, to Feb. 22, 2024, a flood level, and/or specific tags, such as “Hurricane Iris.”

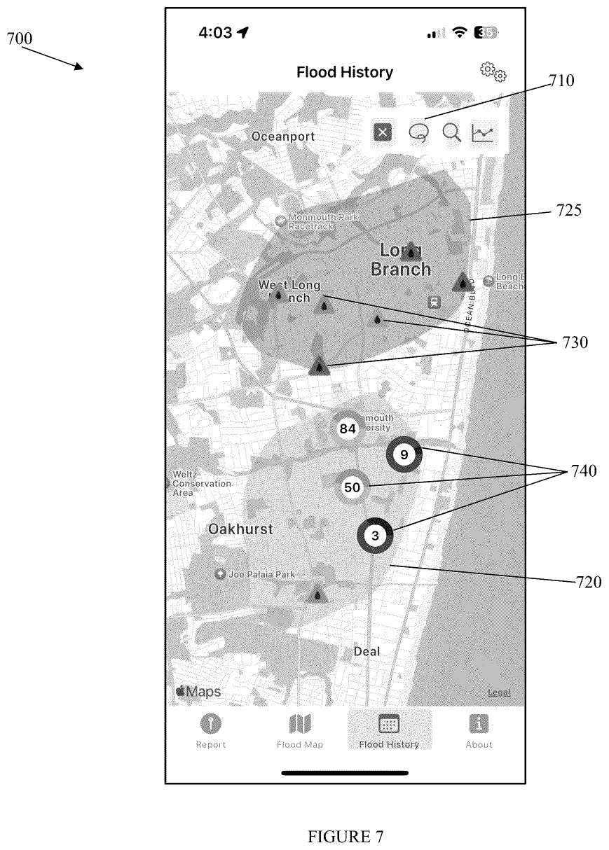

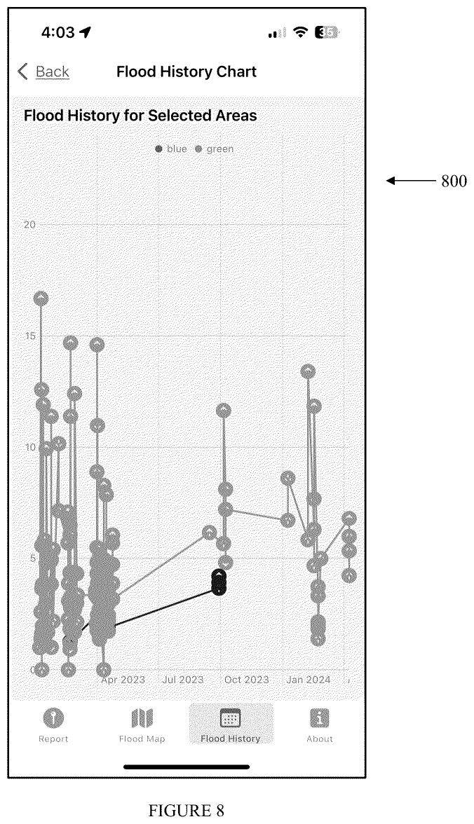

FIG. 7 shows an exemplary flood history map 700 where users can select one or more areas they want to search. A user can select one or more desired areas to search using lasso tool 710, for example. The search queries in the selected areas are sent to the GIS database via data query to process and service as a collection of polygon coordinates. Users tracing one or more areas on the map are captured as a polygon shapes 720, 725, consisting of geolocation coordinates. Search algorithms use the polygons to search through historical data to find the data meeting the requested search criteria. The results are provided and shown to the user on a flood history map 700 with markers 730 and clusters 740. The results provide reported flood incidents inside the selected area with color coded flood levels and clusters. Exemplary chart 800, as shown in FIG. 8, may also be provided showing historical data over extended dates for one or more selected areas. The chart colors may match the color coding shown on the history map.

The present invention allows notifications/messages to be tailored to the individual, which includes offering different languages so that everyone can understand the information received and take the necessary action in the event of an emergency. Being able to understand the information provided is the first step in knowing what action needs to be taken.

The present invention may be created using Mobile App development tools for iOS and Android systems for deployment in iPhone/iPad and Android-based phones respectively. It may also be created using Xcode and a coding language such as SWIFT or Android Studio and Kotlin coding language, for example, as well as other application coding languages. The application is a multi-user application with live connections to a cloud service for receiving flooding data in real time.

It is to be understood that the above description and examples are intended to be illustrative and not restrictive. Many embodiments will be apparent to those of skill in the art upon reading the above description and examples. The scope of the invention should, therefore, be determined not with reference to the above description and examples but should instead be determined with reference to the appended claims, along with the full scope of equivalents to which such claims are entitled. The disclosures of all articles and references, including patent applications and publications, are incorporated herein by reference for all purposes.

What is claimed is:

1. A weather distribution system adapted to collect, analyze and distribute user reported flood data, the system comprising:
a user interface adapted for a user to report flood data, receive a flood alert and view displayed analyzed reported flood data relevant to the user, and
a central cloud network adapted to collect, analyze, and distribute the reported flood data to the user, the central cloud network comprising:
a report handler, wherein the report handler collects the reported flood data, analyzes the reported flood data and distributes the analyzed reported flood data to a memory database and a geographic information system (“GIS”) database;
the memory database, wherein the memory database stores user information and locations;
the GIS database, wherein the GIS database records the analyzed reported flood data;
a notification trigger system, wherein the notification trigger system sends the user the flood alert and displays the analyzed reported flood data based on a user location;
wherein the system automatically updates the displayed reported flood data in real-time.

2. The weather distribution system as recited in claim 1, wherein the analyzed reported data provides flood information for specific local areas and streets.

3. The system as recited in claim 1, wherein the user reported flood data may be descriptive text, drop down menu selections and/or photo or video evidence.

4. The system as recited in claim 1, wherein the GIS database and the memory database record a location of the analyzed reported data, a location of the user, and a timestamp.

5. The system as recited in claim 1, wherein the GIS database conducts advanced analysis of the analyzed reported flood data and queries of the analyzed reported flood data.

6. The system as recited in claim 5, wherein the queries are run using recorded historical analyzed flood data.

7. A method for collecting and distributing the flood reported flood data in real time to a user, the method comprising;
one or more users registering on a flood data system;
the one or more users logging into the flood data system;
the one or more users reporting flood data to the system;
analyzing the reported flood data;
storing the analyzed reported flood data; and
displaying all of the analyzed reported flood data on a user interface in a based on a user's location.

8. The method as recited in claim 7, wherein the displayed analyzed reported flood data includes specific street flood information, increasing or decreasing flood levels, road hazards and/or flood depth levels.

9. The method as recited in claim 7, wherein reporting flood data comprises dropping a location pin where a flood exists, selecting the pin to see street level information, selecting a water icon once the pin is finalized, entering flood data and submitting a flood data report.

10. The method as recited in claim 7, further comprising providing an accurate evacuation route to the user based on the analyzed reported flood data to avoid a flooded travel route.

11. The method as recited in claim 7, further comprising the user updating a previously submitted flood report for an existing data point.

12. The method as recited in claim 7, further comprising filtering the displayed flood data information based on selected user criteria.

13. The method as recited in claim 7, further comprising conducting an advanced search based off of historical analyzed reported flood data.
